(19) United States
(12) Patent Application Publication
(10) Pub. No.: US 2014/0189755 A1
(43) Pub. Date: Jul. 3, 2014

(54) WIRELESS NETWORK ACCESS POINTS BY STB AND SATELLITE ANTENNAE

(71) Applicant: ECHOSTAR TECHNOLOGIES L.L.C., Englewood, CO (US)

(72) Inventor: Rajiv Singh Cullen Pal, Denver, CO (US)

(73) Assignee: ECHOSTAR TECHNOLOGIES L.L.C., Englewood, CO (US)

(21) Appl. No.: 13/732,148

(22) Filed: Dec. 31, 2012

(51) Int. Cl. H04N 21/2665

(52) U.S. Cl. CPC H04N 21/2665
USPC 725/68

(57) ABSTRACT

A satellite dish assembly and a set-top box are utilized to provide an internet wireless hotspot. The set-top box connects to the internet through a modem. The set-top box is coupled to the satellite dish assembly allowing the satellite dish assembly to connect to the internet through the set-top box. An antenna coupled to the satellite dish assembly broadcasts a wireless internet signal allowing a mobile electronic device to connect to the internet through the set-top box.

### BACKGROUND

1. Technical Field

The present disclosure relates to the field of wireless networks. The present disclosure relates more particularly to the field of wireless networks implemented in conjunction with set-top boxes.

2. Description of the Related Art

Portable electronic devices such as smartphones, tablets, and gaming devices commonly connect to wireless networks to connect to the internet. Additionally, mobile devices often connect to cellular telephone networks in order to make telephone calls. Mobile telephone service providers often place a limit on the number of minutes that a user of a cell phone can make phone calls during a given billing period. Other cell phone plans require that a user of a smartphone pay by the minute. Telephone service providers commonly require high prices for data usage (i.e., accessing the internet) over the cellular network. Furthermore, cellular network coverage can be limited and unavailable in many locations.

For these reasons, it is desirable to implement wireless networks having as broad a coverage as possible so that users of mobile devices can access the internet and make phone calls without surpassing their limit on data or minutes limit. Likewise it is desirable to have a wireless network with as broad a range as possible so that users of mobile electronic devices can connect to the internet in as many locations as possible.

### BRIEF SUMMARY

One embodiment is a method for providing a wireless internet hotspot from a satellite dish assembly coupled to a home or other structure. The method includes connecting a set-top box to the internet by establishing a connection with a modem. The modem is connected to the internet through an internet service provider. The method further includes connecting a satellite dish assembly to the internet through the set-top box and broadcasting a wireless network signal from the satellite dish assembly. Mobile devices, such as smart-phones and tablets, within range of the wireless network signal can connect to the internet by communicating with the wireless network signal.

The satellite dish assembly can establish a larger network by communicating with other nearby satellite dish assemblies which are also connected to the internet through respective set-top boxes. A network of linked satellite dish assemblies connected to the internet and acting as wireless hotspots can allow an authorized mobile device to connect to the internet through the network covering a very large area. As the mobile device moves through the area covered by the network, the mobile device's internet connection can be seamlessly passed from one satellite dish assembly to another.

### BRIEF DESCRIPTION OF THE SEVERAL VIEWS OF THE DRAWINGS

FIG. 1 is a block diagram of a home including a satellite communication network according to one embodiment.

FIG. 2 illustrates a neighborhood including multiple satellite dish assemblies broadcasting wireless signals according to one embodiment.

FIG. 3 is a block diagram of a multi-residence wireless network according to one embodiment.

FIG. 4 illustrates a satellite dish assembly according to one embodiment.

FIG. 5 is a flow diagram for implementing a wireless network according to one embodiment.

FIG. 6 illustrates a mobile electronic device according to one embodiment.

### DETAILED DESCRIPTION

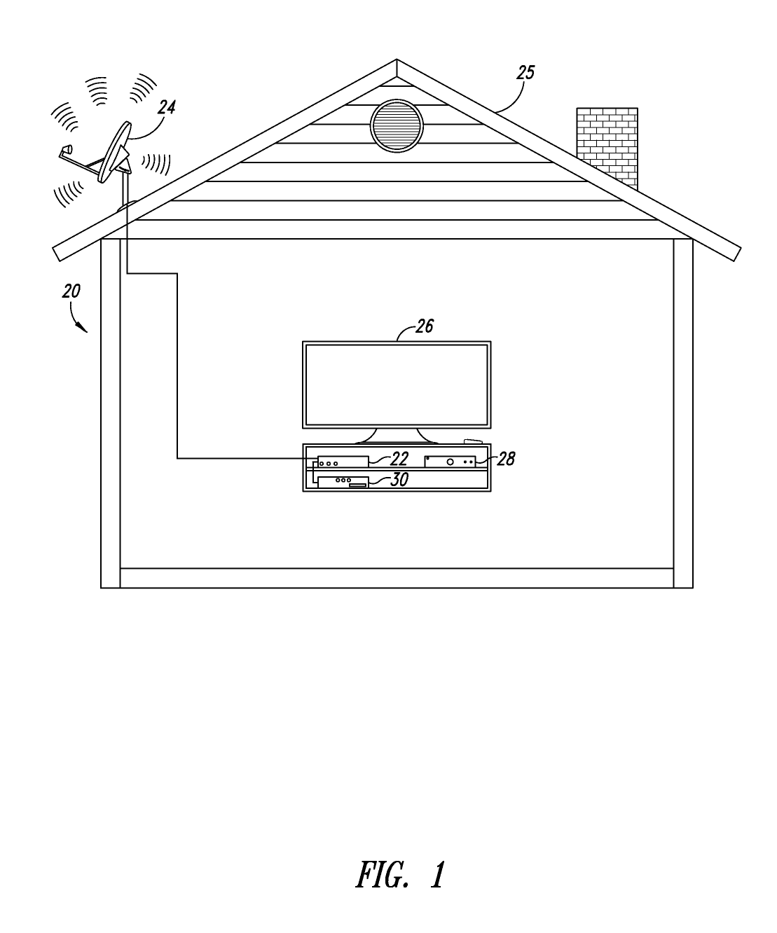

FIG. 1 illustrates a home 20 according to one embodiment. The home 20 includes a television receiver 22 coupled to a satellite dish assembly 24. A television 26 is also coupled to the television receiver 22 and an electronic device 28 is coupled to the television 26. A modem 30 is also coupled to the television receiver 22. The satellite dish assembly 24 is positioned on the roof 25 of the home 20.

The modem 30 is connected to an internet service provider, not illustrated in FIG. 1. The modem 30 communicates with the internet service provider to provide internet access to devices and users in the home 20. The set-top box according to one embodiment connects to the internet through the modem 30. The television receiver 22 may have a wired connection with the modem 30 as shown in FIG. 1 or the television receiver 22 can have a wireless antenna by which the television receiver 22 communicates with the modem 30.

The television receiver 22 receives media content from the satellite dish assembly 24. The satellite dish assembly 24 receives the media content from one or more satellite transponders in orbit above the earth. The satellite transponders provide one or more media content channels to the satellite dish assembly 24, which passes the media content to the television receiver 22. A user of the television receiver 22 can operate the television receiver 22 to display media content on the television 26.

The television receiver 22 and the satellite dish assembly 24 are further configured to pass internet signals between each other. The satellite dish assembly 24 thus can access the internet through the television receiver 22 connected to the modem 30. The satellite dish assembly 24 in turn broadcasts a wireless network signal. A user of a mobile electronic device in range of the wireless internet signal from the satellite dish assembly 24 can log into the wireless network and access the internet through the satellite dish assembly 24.

The satellite dish assembly 24, therefore, acts as a wireless hotspot allowing mobile devices such as smartphones, tablets, laptops, gaming devices, etc., to connect to the internet. Authorized mobile electronic devices can connect to the internet through the signal broadcast by the satellite dish assembly 24.

In one embodiment the satellite dish assembly 24 has two antennas. The first antenna is the dish portion and feedhorn which receive the satellite signals. The second antenna is a conductive portion of the satellite dish assembly that transmits the wireless signal. The satellite dish assembly 24 thus includes a wireless network antenna and a satellite dish assembly antenna. Alternatively, the dish portion of the satellite dish assembly can act as both the wireless antenna and satellite antenna that receives the satellite signals.

In one embodiment, a resident of the home 20 can enter into an agreement with the satellite provider company that provides the satellite dish assembly 24, by which the resident of the home 20 agrees to allow the satellite dish assembly 24 to act as a wireless internet hotspot. The user agrees to supply an internet connection to the satellite dish assembly 24 and broadcast the wireless internet signal form the satellite dish assembly 24. In return, the satellite provider can agree to compensate the resident of the home 20 for sharing her internet bandwidth via the wireless hotspot created by the antenna 24.

The satellite provider can allow users of mobile electronic devices to sign up for a service whereby the user of the mobile electronic device is allowed to access wireless hotspots implemented by the satellite dish assembly 24. Whenever a user of the mobile electronic device is in range of the hotspot created by the satellite dish assembly 24, his mobile device can alert him that he is able to connect to the internet through the satellite provider's wireless internet hotspot. Alternatively, his mobile electronic device can automatically connect to the wireless hotspot.

The satellite provider can enter into an agreement with the user whereby the user can pay for access to the wireless hotspot. Because bandwidth is generally less expensive through a broadband internet service provider than through a cellular data network, it is beneficial to the user of the portable electronic device to connect to the internet through the wireless network broadcast by the satellite dish assembly 24. The user of the portable electronic device can make phone calls over the wireless network via voice over IP (VOIP). The user can also connect to the internet and access email, entertainment websites, news websites or any other kind of data commonly communicated over the internet. This can be particularly beneficial when users are outside of a cellular telephone network's coverage range.

The residents of the home 20, through software installed on the television receiver 22, can limit the bandwidth allotted to the satellite dish assembly 24. In this way, a resident of the home 20 can reserve a desired amount of bandwidth for home use while also allowing users of the satellite provider internet network to access the internet through the satellite dish assembly 24.

In one embodiment the television receiver 22 is a set-top box. Alternatively the television receiver 22 can be integrated part the television 26. The television receiver can also be implemented as part of the electronic device 28, for example in a video game console, a dvd player, a sound system, or other electronic device.

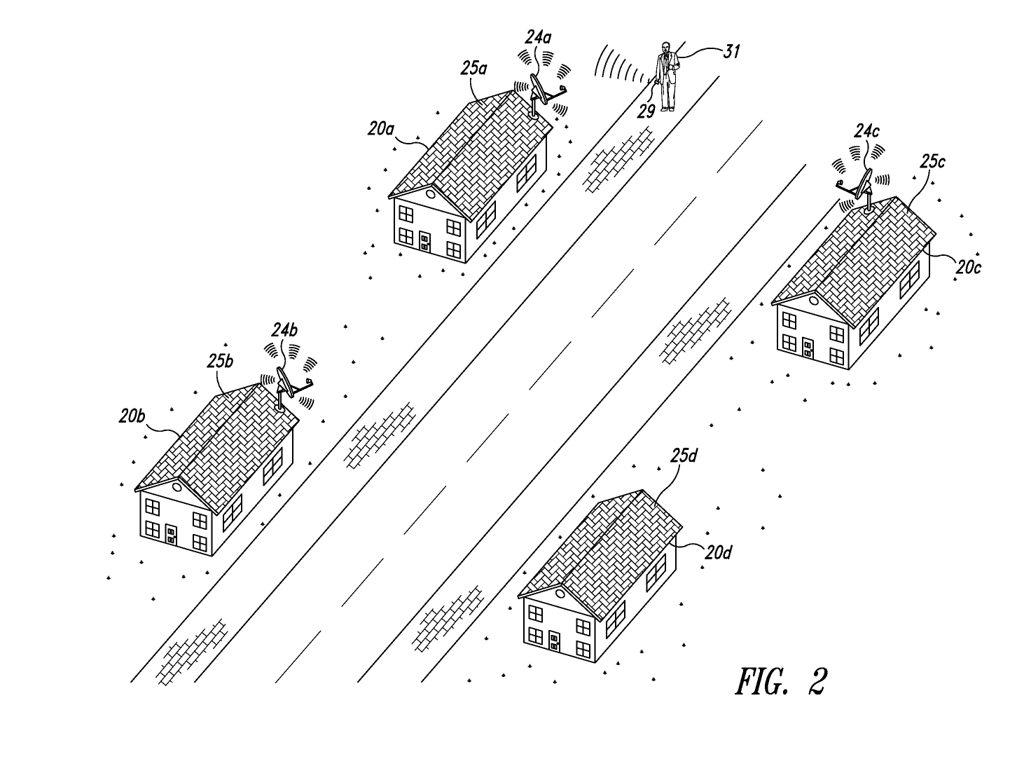

FIG. 2 illustrates a residential area including a plurality of homes 20a-20d. Homes 20a-20c include respective satellite dish assemblies 24a-24c coupled to respective roofs 25a-25c. Home 20d does not include a satellite dish assembly. Each satellite dish assembly 24a-24c broadcasts a wireless internet signal. Each satellite dish assembly 24a-24c acts as a wireless hotspot as described in relation to FIG. 1. Each home 20a-20c, therefore, has a respective set-top box and modem through which the satellite dish assemblies 24a-24c can connect to the internet. The residents of each home 20a-20c have agreed with the satellite provider to broadcast an internet signal from their respective satellite dish assemblies 24a-24c as described in relation to FIG. 1.

The satellite dish assemblies 24a-24c are also in communication with each other via the wireless internet signal and establish a single wireless network. In one example, the satellite dish assemblies 24a and 24b are in range of each other's signals and establish a wireless network with each other. The satellite dish assembly 24c is also in range of the satellite dish assembly 24a and is incorporated in the larger wireless network. Thus, although the satellite dish assemblies 24b and 24c are not directly in range of each other, they are linked together in the network by the satellite dish assembly 24a. In this way a single large wireless network can be established by wirelessly linking adjacent satellite dish assemblies.

FIG. 2 further illustrates a person 31 holding a portable electronic device 29. The person 31 is walking down a sidewalk near the home 20a. As the person 31 enters the range of the wireless signal broadcast by the satellite dish assembly 24a, the portable electronic device 29 issues an alert notifying the person 31 that a wireless network is available. Alternatively, as described previously, the portable electronic device 29 can automatically connect to the wireless network when in range. The person 31 using the portable electronic device 29 can now access the internet through the satellite dish assembly 24a. Person 31 can use the wireless network to make telephone calls via VOIP or to access internet content as described previously.

As the person 31 continues to walk down the street, he comes into range of the signal being broadcast by the antenna 24b. Because the satellite dish assembly 24a and the satellite dish assembly 24b have established a wireless network connection with each other, the user of the portable electronic device 29 can seamlessly remain connected to the internet as he passes out of range of the satellite dish assembly 24a and into range of the satellite dish assembly 24b.

In one embodiment, the portable electronic device 29 automatically accesses the internet through the satellite dish assembly 24b when the strength of the wireless signal being broadcast by the satellite dish assembly 24b is stronger than the wireless signal being broadcast by the satellite dish assembly 24a as received by the portable electronic device 29. Alternatively, the internet connection of the portable electronic device 29 can be transferred between the satellite dish assemblies 24a-24c in another suitable manner as will be apparent to those of skill in the art in light of the present disclosure.

In one embodiment, the signals broadcast by the satellite dish assemblies 24a-24c are sufficiently strong such that a network can be established between them even if there are houses spaced between them. In this way, a very large wireless network can be established as long as there are enough satellite dish assemblies in a given neighborhood, residential area, commercial area or anywhere else. It is possible that entire cities could be covered by a massive wireless network created by a large number of satellite dish assemblies 24 linked together in a spider web fashion. Such a large network could compete with telephone data networks. Those that subscribe to the wireless internet service via their portable electronic devices 29 could be able to access more internet data and talk on the phone longer for a lower price than if they tried to access the same data and phone minutes through their cellular telephone network.

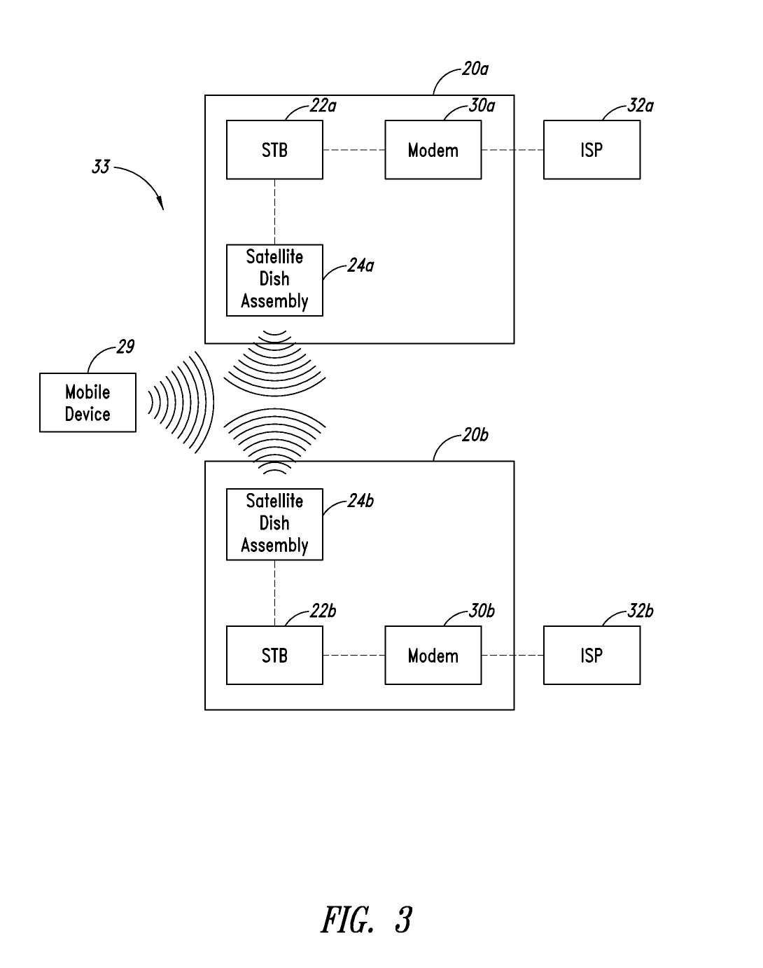

FIG. 3 is a block diagram of a wireless network 33 according to one embodiment. The wireless network 33 is established by satellite dish assemblies 24a and 24b. Wireless network 33 includes a first home 20a and a second home 20b. The first home 20a includes a television receiver 22a coupled to a modem 30a. The modem 30a is connected to an internet service provider 32a. The television receiver 22a is, therefore, connected to the internet service provider 32a through the modem 30a. Antenna 34a is coupled to the television receiver 22a. The satellite dish assembly 24a connects to the internet service provider 32a through the modem 30a via the television receiver 22a. The satellite dish assembly 24a acts as a wireless hotspot by broadcasting a wireless internet signal.

The home 20b includes a second television receiver 22b connected to a modem 30b. The modem 30b is connected to an internet service provider 32b. The television receiver 22b can access the internet service provider 32b via the modem 30b. Satellite dish assembly 24b is coupled to the television receiver 22b. The satellite dish assembly 24b connects to the internet service provider 32b through the modem 30b via the television receiver 22b. The satellite dish assembly 24b is a wireless hotspot and broadcasts a wireless internet signal.

The satellite dish assemblies 24a, 24b establish a network connection between each other by sharing wireless internet signals. The satellite dish assemblies 24a, 24b therefore broadcast data signals to each other establishing a network connection and identifying devices connected to the network. In addition to the network signal passed between the satellite dish assemblies 24a, 24b, the satellite dish assemblies 24a, 24b broadcast a network signal allowing a mobile device 29 to connect to the internet through the satellite dish assemblies 24a, 24b. When the mobile device 29 is in range of the signal broadcast by the satellite dish assembly 24a, the mobile device 29 can connect to the network established by the satellite dish assemblies 24a, 24b. If the mobile device is in range of the satellite dish assembly 24a but not in range of the antenna 24b, then the mobile device 29 communicates wirelessly with the satellite dish assembly 24a. The mobile device 29 can access the internet service provider 32a via the satellite dish assembly 24a.

In one embodiment, the satellite dish assembly 24a continuously broadcasts the network identification signal. When the mobile device 29 receives the network identification signal, the mobile device 29 can broadcast a request to log into the network 33. The mobile device 29 can broadcast identification codes including login information allowing the mobile device 29 to access the network 33. The satellite dish assembly 24a can pass the login information from the mobile device 29 to the modem 30a and to the internet through the internet service provider 32a. Login verification can be performed via the internet. When it is determined that the mobile device 29 is authorized to access the network 33, the mobile device 29 can access the internet service provider 32a through the satellite dish assembly 24a as described previously.

While the mobile device 29 is accessing the internet through the satellite dish assembly 24a, the satellite dish assembly 24a broadcasts a signal to the satellite dish assembly 24b indicating that the mobile device 29 is connected to the network 33. When the mobile device 29 comes into range of both the satellite dish assembly 24a and the satellite dish assembly 24b, access to the internet for the mobile device 29 can be passed to the satellite dish assembly 24b without interruption of service. For example, when the mobile device 29 is in range of the antenna 24b, the mobile device 29 can access the internet through the internet service provider 32b via the antenna 24b. The antenna 34b can alert any other satellite dish assembly 24ᵢ that the mobile device 29 is accessing the internet through the satellite dish assembly 24b. In this manner, the mobile device 29 can continue to access the internet through the network 33 as the signal is passed through whichever antenna is closest to the mobile device 29.

Alternatively, the network 33 can be configured such that the bandwidth required by the mobile device 29 can be passed to whichever satellite dish assembly 24a or 24b has the most available bandwidth.

When multiple mobile devices 29 are connected to the network 33, the satellite dish assemblie 24a, 24b or other antennas can pass the signals from the mobile devices 29 amongst themselves so that the satellite dish assembly with the highest available bandwidth can provide a bandwidth to each of the mobile devices 29. The network 33 can pair more devices on satellite dish assembly 24a than on satellite dish assembly 24b if satellite dish assembly 24a has the greater available bandwidth. Many other schemes and protocols can be implemented for apportioning bandwidth to mobile devices 29 connected to the network 33 as will be apparent in light of the present disclosure.

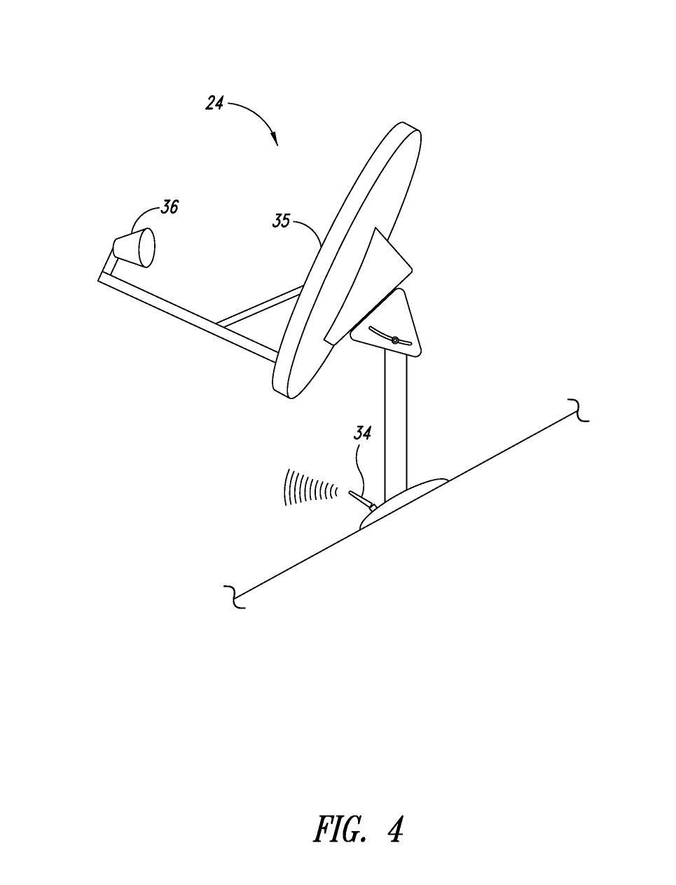

FIG. 4 illustrates a satellite dish assembly 24 having a wireless antenna 34 coupled thereto. The satellite dish assembly includes dish portion 35 and feedhorn 36. The dish portion 35 and feedhorn 36 together act as an antenna to receive satellite signals from a satellite transponder in orbit. The satellite signals include media content such as television channels that will be passed from the satellite dish assembly 24 to a television receiver 22 of a home 20.

The wireless antenna 34 is coupled to a base of the satellite dish assembly 24. The antenna 34 connects to the internet through a modem 30 by way of the television receiver 22. As described previously, the television receiver 22 is coupled to the modem 30 which can access the internet through an internet service provider 32. The television receiver 22 is coupled to the satellite dish assembly 24 and can allow the satellite dish assembly 24 to access the internet through the modem 30. The wireless antenna 34, in particular, can broadcast a wireless internet signal allowing the satellite dish assembly to act as an internet hotspot as described previously. A person using a mobile device 29 can access the internet by connecting to the wireless network that is broadcast by the antenna 34.

While the satellite dish assembly 24 has been described as having a separate antenna 34 for broadcasting the wireless internet signal, in one embodiment the satellite dish assembly 24 itself acts as the antenna that broadcasts the wireless internet signal. In such an embodiment, a conductive portion of the satellite dish assembly 24 can act as an antenna transmitting and receiving wireless internet signals. The satellite dish assembly 24, therefore, can simultaneously acts as a receiver for satellite signals from a satellite transponder as well as an antenna for transmitting and receiving a wireless internet signal locally. In one embodiment the dish portion 35 both receives the satellite signals and transmits the wireless internet signal. The dish portion 35 thus can act as both a both satellite signal antenna and a wireless internet signal antenna. Other methods for implementing a wireless antenna 34 with a satellite dish assembly 24 can be implemented as will be apparent to those of skill in the art in light of the present disclosure.

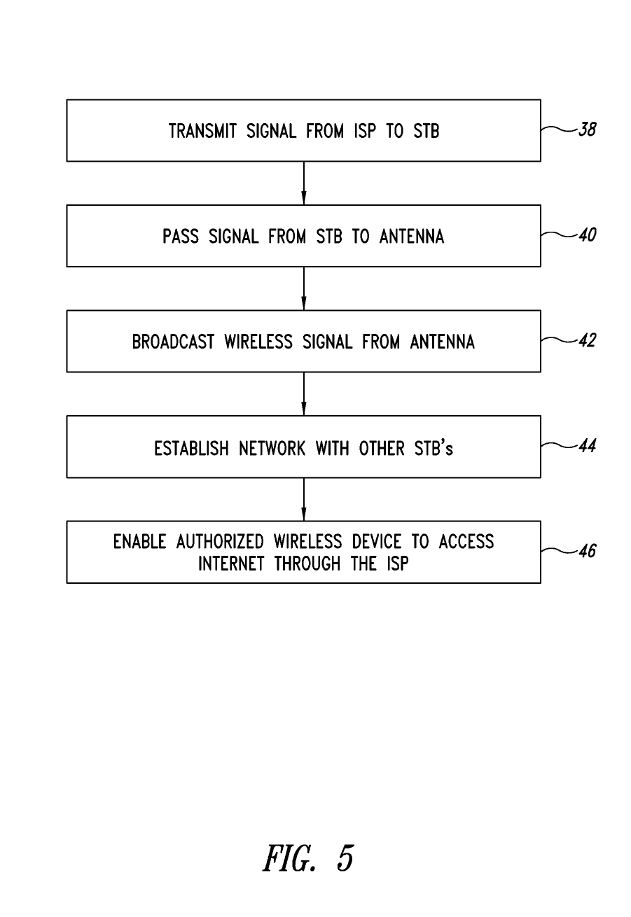

FIG. 5 illustrates a flow chart establishing a wireless network using satellite dish assemblies 24 coupled to set-top boxes 22. At step 38 an internet signal is transmitted from an internet service provider 32 to a television receiver 22. The internet signal can be passed to the television receiver 22 through a modem 30 as described previously. At step 40, the internet signal is passed from the television receiver 22 to a satellite dish assembly 24. At step 42, the satellite dish assembly broadcasts a wireless network signal. The wireless network signal is configured to allow authorized devices to connect to the internet through the satellite dish assembly 24 through the television receiver 22 through the modem 30 through the internet service provider 32. In steps 30 and 40, an internet signal has been transmitted from the internet service provider 32 to the television receiver 22 and on to the satellite dish assembly 24. In practice, many signals will be passing back and forth between the internet service provider 32 and the satellite dish assembly 24. These signals will pass through the modem 30 and the television receiver 22 as described previously. Additionally, the television receiver 22 provides network information to the satellite dish assembly 24 for establishing the wireless network.

At step 44, the satellite dish assembly 24 communicates with other satellite dish assemblies, which are, in turn, connected to other set-top boxes. In this manner, the satellite dish assembly 24 can establish the wireless network with other set-top boxes through the other satellite dish assemblies. At step 46, a mobile device 29 receives the wireless internet signal from the satellite dish assembly 24 and transmits an identification signal to the satellite dish assembly 24. The satellite dish assembly 24 receives the identification signal and passes the identification signal to the television receiver 22. The television receiver 22 receives the identification signal from the satellite dish assembly 24 and extracts an identification code from the identification signal. The identification code identifies the mobile device 29 as a device authorized to access the wireless network. The mobile device 29 is then authorized to access the internet by joining the wireless network. The mobile device 29 can access the internet by communicating wirelessly with the satellite dish assembly 24. The satellite dish assembly 24 communicates with other satellite dish assemblies and identifies what devices are connected to the network. Thus, all of the satellite dish assemblies connected to the satellite dish assembly 24 know which devices are currently connected to the wireless network. When the mobile device 29 passes into range of another satellite antenna 24 broadcasting the internet signal, the mobile device 29 can be seamlessly transferred to the other satellite dish assembly and can access the internet through the other satellite dish assembly.

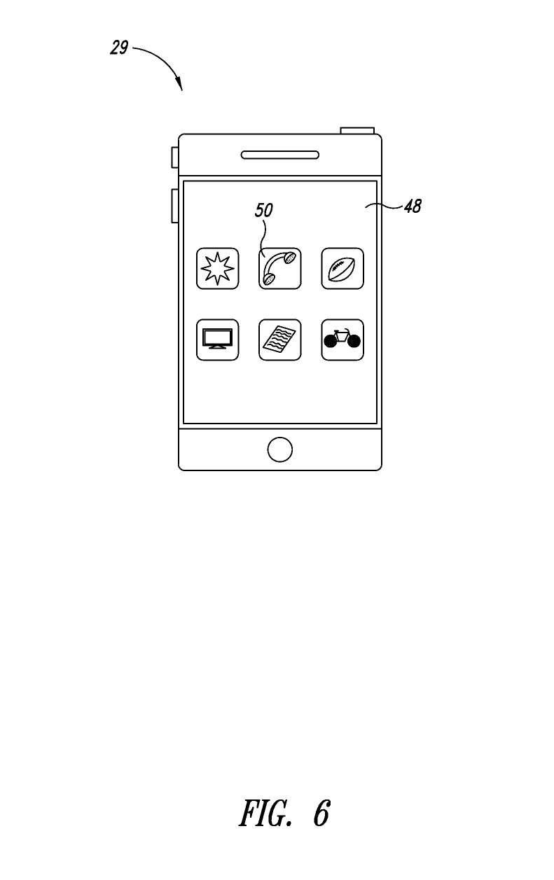

FIG. 6 illustrates a mobile electronic device 29. The mobile electronic device 29 is, for example, a smartphone. The mobile electronic device 29 includes a display 48 displaying icons which each represent software applications installed on the mobile electronic device 29. The mobile electronic device 29 includes an application 50 used in conjunction with accessing the wireless network 33 as described previously. In one example, a user of the mobile electronic device 29 can download the application 50 and install it on the mobile electronic device 29. Upon using the application 50, the user of the portable electronic device 29 can register the portable electronic device to be able to access the wireless network 33. The application 50 is therefore provided by the satellite provider or other company that operates and manages the wireless network's broadcast from the satellite dish assemblies.

In one embodiment, a user of the mobile electronic device 29 registers the mobile electronic device 29 by entering personal information and submitting payment through the application 50. Thereafter, the mobile electronic device 29 is authorized to access the wireless network 33 created by the satellite dish assembly 24 in connection with the television receiver 22. After the user has registered the mobile electronic device to be able to use the wireless networks 33, data is sent to the satellite provider including an identification profile that identifies the user and the mobile electronic device 29 as being authorized to access the wireless network 33. In one embodiment, when a user of the mobile electronic device 29 is in range of the wireless network 33, identification codes are sent from the mobile electronic device 29 to the television receiver 22 through the satellite dish assembly 24. The television receiver 22 can determine if the mobile electronic device 29 is authorized by transmitting the identification information over the internet to the satellite provider company, which can then affirm authorization of the mobile electronic device 29 to use the wireless network 33.

The various embodiments described above can be combined to provide further embodiments.

These and other changes can be made to the embodiments in light of the above-detailed description. For example, while the pairing signal and the control signals have been described as being issued in different frequency bands, in one embodiment the pairing signal is issued in the same frequency band as the control signals, but the pairing signal is transmitted at a much lower power than the control signals so as to only be received by one of the set-top boxes 24, 26. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, in a first satellite dish assembly, media content from a satellite transponder;
providing the media content from the satellite dish assembly to a first television receiver;
connecting the first television receiver to an internet service provider;
connecting the first satellite dish assembly to the internet service provider through the first television receiver;
transmitting, from the first satellite dish assembly, a wireless internet network signal; and
connecting a mobile electronic device to the internet service provider through the first television receiver by establishing a wireless network connection with the first satellite dish assembly.

2. The method of claim 1 comprising coupling the first television receiver to a modem configured to connect to the internet service provider.

3. The method of claim 2 wherein coupling the first television receiver to the modem includes wirelessly passing signals between the first modem and the first television receiver.

4. The method of claim 1 wherein transmitting the wireless internet network signal includes transmitting the wireless internet network signal from an antenna coupled to the satellite dish assembly.

5. The method of claim 1 comprising:
transmitting the wireless network signal from the first satellite dish assembly to a second satellite dish assembly; and
establishing a second wireless network connection between the first satellite dish assembly and the second satellite dish assembly.

6. The method of claim 5 comprising transmitting from the second satellite dish assembly a second wireless network signal configured to allow a second mobile electronic device to connect to the internet.

7. The method of claim 6 wherein the second satellite dish assembly is configured to connect to the internet through a second television receiver.

8. The method of claim 6 wherein the second satellite dish assembly is configured to connect to the internet through the first television receiver.

9. A system comprising:
a television receiver configured to connect to an internet service provider through a modem; and
a satellite dish assembly configured to connect to the internet service provider through the television receiver and to transmit a wireless network signal configured to allow a mobile electronic device to establish a wireless network connection with the satellite dish assembly and to connect to the internet through the television receiver.

10. The system of claim 9 wherein the satellite dish assembly includes:
a first antenna configured to receive a satellite signal from a satellite transponder; and
a second antenna configured to transmit the wireless network signal.

11. The system of claim 9 wherein the satellite dish assembly is configured to establish a second wireless network connection with a second satellite dish assembly.

12. The system of claim 11 wherein the satellite dish assembly is configured to exchange user identification data with the second satellite dish assembly, the user identification data identifying a second mobile electronic device accessing the internet through the second satellite dish assembly.

13. The system of claim 12 wherein the satellite dish assembly is configured to maintain an internet connection of a second mobile electronic device when the second mobile electronic device moves out of range of the second satellite dish assembly.

14. A method comprising:
exchanging internet data between a set-top box and a satellite dish assembly, the set-top box configured to access the internet through a modem, the satellite dish assembly configured to access the internet through the set-top box;
broadcasting a wireless network signal from the satellite dish assembly;
establishing a wireless network connection between the satellite dish assembly and a portable electronic device via the wireless network signal; and
providing internet access to the mobile electronic device via the wireless network connection.

15. The method of claim 14 comprising:
receiving, at the satellite dish assembly, a user identification code from the mobile electronic device;
transmitting the user identification code from the satellite dish assembly to the set-top box; and
determining if the mobile electronic device is authorized to access the internet through the satellite dish assembly.

16. The method of claim 15 wherein the determining includes:
transmitting the identification code over the internet to a central server; and
receiving confirmation from the central server that the mobile electronic device is authorized to access the internet through the satellite dish assembly.

17. The method of claim 14 comprising limiting internet bandwidth allotted to the satellite dish assembly by executing software instructions stored in the set-top box.

18. The method of claim 14 comprising establishing a second wireless network connection between the satellite dish assembly and a second satellite dish assembly.
